(19) United States
(12) Patent Application Publication
(10) Pub. No.: US 2021/0013719 A1
(43) Pub. Date: Jan. 14, 2021

(54) ENERGY STORAGE SYSTEM AND METHOD FOR CONTROLLING AN ENERGY STORAGE SYSTEM

(71) Applicant: Aggreko Deutschland GmbH, Dorsten (DE)

(72) Inventor: Benjamin Joseph Braun, Berlin (DE)

(73) Assignee: Aggreko Deutschland GmbH, Dorsten (DE)

(21) Appl. No.: 16/980,736

(22) PCT Filed: Mar. 13, 2019
(86) PCT No.: PCT/EP2019/056296

§ 371 Date: Sep. 14, 2020

(30) Foreign Application Priority Data
Mar. 14, 2018 (DE) 10 2018 203 889.9

(51) Int. Cl. H02J 3/32; H01F 29/02; G05F 1/14

(52) U.S. Cl. CPC H02J 3/32; G05F 1/14; H01F 29/025

(57) ABSTRACT

An energy storage system is disclosed. The energy storage system includes at least one energy store, a power convertor for converting between a DC voltage present at the at least one energy store and an AC voltage, a transformer for transforming between the AC voltage and a line voltage of an energy supply network, and a control device for controlling the energy storage system. The transformer is switchable for setting a transformation ratio for converting between the AC voltage and the line voltage, wherein the control device is configured to set the transformation ratio of the transformer depending on the DC voltage present at the at least one energy store.

### CROSS-REFERENCE TO A RELATED APPLICATION

This application is a National Phase Patent Application of International Patent Application Number PCT/EP2019/056296, filed on Mar. 13, 2019, which claims priority of German Patent Application Number 10 2018 203 889.9, filed on Mar. 14, 2018.

### BACKGROUND

The disclosure relates to an energy storage system and to a method for controlling an energy storage system.

Such an energy storage system, for example a battery storage system (also referred to as battery power plant), comprises at least one energy store, for example one or more battery devices for storing electrical energy, a power convertor for converting between a DC voltage present at the at least one energy store and an AC voltage, a transformer for transforming between the AC voltage and a line voltage of an energy supply network, and a control device for controlling the energy storage system.

In order to control the line voltage and line frequency of electrical energy supply networks, besides conventional power plants with rotary electrical generators, battery storage units in the megawatts range are also used as part of an efficient control concept with central and decentralized control tasks. The battery storage units, also referred to as “battery power plant”, differ from the energy storage units currently used for primary control in particular by virtue of their rapidity and good controllability when providing primary control power and are therefore also connected to existing electrical energy supply networks and used for primary control.

In the case of a method known from WO 2014/1700373 A2, for this purpose a battery power plant is largely kept in an optimum state of charge that ensures, for primary control, both that electrical power is taken up from the electrical energy supply network and that electrical power is output to the electrical energy supply network.

Generally the DC voltage available at an electrical energy store in the form of a battery changes depending on the state of charge (SOC for short) of the battery. In order to feed energy into an energy supply network, the DC voltage provided by the battery is converted into an AC voltage by means of a power convertor and transformed toward the line voltage (in the kilovolts range, for example 20 kV) by a (power) transformer. Conversely, in order to charge the battery, the line voltage is transformed into the AC voltage by means of the transformer and converted into a DC voltage for feeding into the battery by means of a power convertor. By means of such energy storage systems, particularly in the form of battery power plants, it is possible to temporarily store energy from renewable energy sources, for example, by energy being drawn from an energy supply network in the event of a surplus and being fed into the energy supply network again at a different point in time.

Conventional energy storage systems of this type usually use an AC voltage in the form of an intermediate voltage that is constant in terms of its root-mean-square value so as to provide the required line voltage on the network side by transforming said intermediate voltage. In order to provide the AC voltage in the form of the constant intermediate voltage, a battery power plant must either rate the required intermediate voltage in a manner dependent on (and limited by) the minimum DC voltage provided by the energy storage units or additionally use a (DC-DC) convertor that compensates for fluctuations in the DC voltage present at the energy store in the form of a battery and converts between the DC voltage on the output side of the battery and a required DC voltage on the input side of the power convertor. This may possibly be accompanied by losses, is additionally complex in terms of construction and in terms of control and is therefore not usable under certain circumstances in the case, in particular, of large energy storage systems (of an order of magnitude of, for example, beyond 50 MW, for example 100 MW).

Moreover, in the case of such a procedure, the capacity of an energy store in the form of a battery may possibly not be fully utilized, with the result that the battery is possibly not readily usable particularly in very low states of charge. Even in the case of such a procedure, however, the efficiency will be detrimentally affected in particular at times with a large separation between DC voltage and AC voltage during operation under partial load.

### SUMMARY

It is an object underlying the proposed solution to provide an energy storage system and a method for controlling the energy storage system which make it possible to operate an energy storage system with a high efficiency even when power is low.

This object is achieved by means of an energy storage system having features as described herein.

Accordingly, the transformer is switchable for setting a transformation ratio for converting between the AC voltage and the line voltage, wherein the control device is configured to set the transformation ratio of the transformer depending on the DC voltage present at the at least one energy store.

Accordingly, the transformer (configured in particular as a power transformer) is switchable in particular in a stepwise manner for setting the transformation ratio. The transformation ratio is set depending on a DC voltage present at the at least one energy store, for example a battery, which makes it possible, in particular, to use an AC voltage that is variable in terms of its root-mean-square value between the DC voltage on the part of the energy store and the line voltage on the part of the energy supply network.

By means of the energy storage system provided, it is possible, if appropriate, to dispense with a (DC-DC) convertor for adapting the DC voltage between the energy store and the power convertor, which makes it possible to operate the energy storage system with high efficiency. The fact that the transformation ratio can be adapted to a DC voltage present by switching over the transformer additionally makes it possible to utilize a storage capacity of an energy store in the form of a battery in an expedient way.

In particular, the proposed solution makes it possible to fully utilize DC energy storage units even in a low state of charge.

Generally, the smallest DC voltage present at an energy storage unit determines the maximum AC voltage that can be provided by the power convertor. The proposed solution makes it possible to convert larger DC voltages available at energy storage units into higher AC voltages, which not only makes it possible to enable a better efficiency in the partial load range, but also opens up the possibility of using a higher power of the power convertor at least for a short period, namely as long as a corresponding state of charge exists.

In the context of the present text, an “energy supply network” is understood to mean a high-voltage transmission network, a medium-voltage distribution network or else a low-voltage network, wherein an energy storage system connected to a distribution network at the medium-voltage level can provide system services such as primary power control in the high-voltage transmission network also indirectly via the distribution network level.

The transformer can have in particular a secondary winding, at which the AC voltage is present, a primary winding, at which the line voltage is present, and a switching device with a plurality of secondary taps at the secondary winding and/or with a plurality of primary taps at the primary winding. By means of such taps, the windings can be tapped at different points in order in this way to vary the effective winding length (and thus the effective number of turns of the respective winding) and thereby to set the transformation ratio of the transformer, which is dependent on the ratio of the (effective) number of turns of the windings.

The switchover between the taps is effected by way of the switching device, wherein it is possible to switch over between secondary taps at the secondary winding on the part of the power convertor and additionally or alternatively between primary taps at the primary winding on the part of the energy supply network in order in this way to vary in a stepwise manner the effective length of the secondary winding on the part of the power convertor and/or the effective length of the primary winding on the part of the line voltage.

In this case, the steps of the switchover are predefined by the locations of the taps, such that the transformation ratio can be varied in a stepwise manner by way of the switching device. In this case, the steps can be arranged equidistantly with respect to one another, such that the transformation ratio can be adapted in uniform steps. However, the steps can also be of different magnitudes, such that the transformation ratio can be adapted with steps of different magnitudes.

The switching device, also referred to as tap switch, can be configured as a so-called on load tap changer (OLTC for short). Alternatively, however, the switching device can also be configured as a so-called no load tap changer (NLTC for short).

The transformer is thus preferably switchable in a stepwise manner in order to vary the transformation ratio at the transformer and to adapt it to a DC voltage available at the at least one energy store, for example a battery, said DC voltage being dependent on the state of charge of the energy store. While the transformation ratio is thus variable in a stepwise manner, the DC voltage available at the energy store will change continuously with the changing state of charge of the battery. In order to transform between the AC voltage and the line voltage (which is constant in terms of root-mean-square value), provision is preferably made, therefore, for controlling the power convertor for converting between the DC voltage and the AC voltage such that the root-mean-square value of the AC voltage is variable depending on the value of the DC voltage, but in the process is preferably set on the basis of a step function, such that the root-mean-square value of the AC voltage is varied in a stepwise manner. Consequently, different steps of the AC voltage are assigned to different value ranges of the DC voltage, such that a specific value range of the DC voltage is converted into a specific step of the AC voltage.

The power convertor serves to convert the DC voltage of the energy store into the AC voltage in the direction of an infeed into the energy supply network, said AC voltage then being transformed into the line voltage by means of the transformer. The power convertor operates as an inverter in this direction. By contrast, in the direction of drawing energy from the energy supply network, for charging the energy store, in particular the battery, the AC voltage obtained from the line voltage is converted, by means of the power convertor, into the DC voltage of the energy store for feeding the energy into the energy store. The power convertor operates as a rectifier in this direction. In both directions the power convertor is configured in a controllable fashion, in particular using semiconductor components, for example transistors such as IGBTs, such that depending on the DC voltage available at the energy store (said DC voltage being dependent on the state of charge of the energy store, in particular the battery) a conversion between the DC voltage and the AC voltage (which is set to a step assigned to the value of the DC voltage and is thus varied in a stepwise manner) is effected.

The root-mean-square value of the AC voltage can be set by means of pulse width modulation, in particular. In this case, a modulation factor of the pulse width modulation is predefined by means of the control device, wherein the modulation factor is calculated on the basis of the available value of the DC voltage. By way of example, for inversion for converting the DC voltage of the energy store for feeding into the energy supply network with semiconductor switching elements from the available DC voltage by means of pulse width modulation (PWM for short), a sinusoidal AC voltage composed of short pulses of high frequency is simulated (so-called sinusoidal invertor). For this purpose, transistors (in particular IGBTs) used as switching elements periodically reverse the polarity of the DC voltage, wherein the root-mean-square value of the converted AC voltage is set on the basis of the modulation factor of the pulse width modulation. This is effected in such a way that a predetermined step of the AC voltage (relative to the root-mean-square value of the AC voltage) is established which is assigned to a specific step of the transformation ratio of the transformer.

The transformation ratio of the transformer is then set on the basis of the set step of the AC voltage. The stepwise variation of the AC voltage available on the output side of the power convertor and the stepwise setting of the transformation ratio on the basis of the steps of the AC voltage ensure that the AC voltage can be converted into the line voltage (which is constant in terms of its root-mean-square value) in a desired manner.

The energy storage system is preferably configured as a battery storage power plant comprising an energy store in the form of a battery device. In this case, the energy storage system can have a high power, for example greater than 30 MW, for example even greater than 50 MW or 100 MW.

The object is also achieved by means of a method for controlling an energy storage system, wherein a power convertor converts between a DC voltage present at least one energy store and an AC voltage, and a transformer transforms between the AC voltage and a line voltage of an energy supply network. In this case, it is provided that the transformer is switched for setting a transformation ratio for converting between the AC voltage and the line voltage depending on the DC voltage present at the at least one energy store.

The advantages and advantageous configurations described above for the energy storage system analogously find application to the method as well, and so in this regard reference should be made to the explanations given above.

### BRIEF DESCRIPTION OF THE DRAWINGS

The concept underlying the proposed solution shall be explained in greater detail below on the basis of the exemplary embodiments illustrated in the figures.

FIG. 1 shows a schematic view of an energy storage system in the form of a

FIG. 2 shows a schematic view a branch of one exemplary embodiment of an energy storage system;

FIG. 3 shows a schematic view of a transformer.

FIG. 4 shows a view of a winding of the transformer with a switching device in the form of a tap switch for switching the transformation ratio of the transformer.

FIG. 5A shows a graphical view of the DC voltage available at an energy store in the form of a battery depending on the state of charge.

FIG. 5B shows a graphical view of a stepwise conversion of the DC voltage by means of a power convertor into an AC voltage with parallel stepping of a transformer.

FIG. 5C shows a graphical view of a resulting line voltage.

FIG. 6 shows a graphical view of the conversion by means of pulse width modulation.

### DETAILED DESCRIPTION

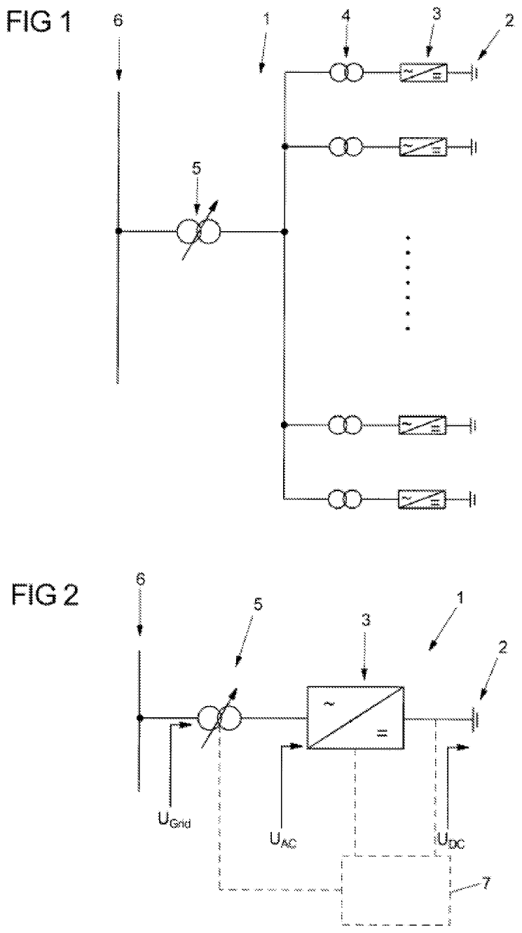

FIG. 1 shows, in a schematic view, an energy storage system 1 in the form of a battery power plant having a plurality of energy stores 2 in the form of batteries. The energy storage system 1 is coupled to an energy supply network 6 and serves to temporarily store energy from renewable energy sources, for example, in order, even from a state of the energy supply network 6, to feed energy into the energy supply network 6 or to draw energy from the energy supply network 6 for temporary storage.

An energy store 2 in the form of a battery provides a DC voltage that can vary depending on the state of charge of the battery 2. Conversion is effected between the DC voltage of the energy store 2 in the form of the battery and the line voltage present on the part of the energy supply network 6 by means of power convertors 3 and a transformer 5, wherein in the exemplary embodiment in accordance with FIG. 1 separate power convertors 3 are assigned to different energy stores 2 and the AC voltage of the energy stores 2 that is obtained in this way is transformed to the line voltage of the energy supply network 6 by means of a common transformer 5.

The transfer chain between the energy supply network 6 and energy stores 2 is configured for feeding energy from the energy stores 2 into the energy supply network 6 and conversely also for feeding energy from the energy supply network 6 into the energy stores 2 in the form of the batteries. In the direction of feeding energy from the energy stores 2 into the energy supply network 6, the power convertors 3 in this case act as invertors for converting the DC voltage of each energy store 2 into an AC voltage, which is then transformed into the line voltage U_{Grid} by means of the transformer 5. By contrast, in the direction of feeding energy from the energy supply network 6 into the energy stores 2, the power convertors 3 act as rectifiers for rectifying the AC voltage obtained after transformation at the transformer 5 into the DC voltage of the respective energy store 2.

In the case of the exemplary embodiment in accordance with FIG. 1, a generator transformer 4 serving for transformation and as galvanic isolation is additionally present in each path of an energy store 2.

In the case of the exemplary embodiment in accordance with FIG. 2 (which schematically illustrates a path assigned to an energy store 2), the conversion of the DC voltage U_{DC} of the energy store 2 into the AC voltage U_{AC} and the transformation of the AC voltage U_{AC} into the line voltage U_{Grid} of the energy supply network 6 are effected in a manner controlled by way of a control device 7. In this regard, the transformer 5 is switchable in a stepped manner for setting the transformation ratio, such that the transformer 5 does not have a constant transformation ratio, but rather is able to be switched over in a controlled manner.

Likewise, the AC voltage U_{AC} between power convertor 3 and transformer 5 is not constant in terms of its root-mean-square value, but rather is settable in a variable manner, depending in particular on the DC voltage available at the energy store 2, said DC voltage being dependent on the state of charge of the energy store 2 in the form of the battery.

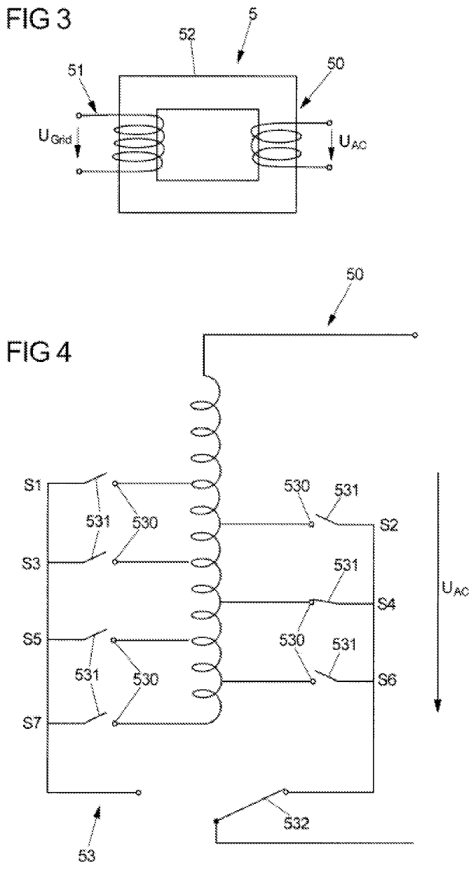

As is illustrated in FIG. 3, the transformer 5 has a secondary winding 50, at which the AC voltage U_{AC} is present, and a primary winding 51, at which the line voltage U_{Grid} is present, which are operatively connected to one another in a transformer-based manner via a transformer core 52 for guiding the magnetic flux. The transformation ratio of the transformer 5 results from the ratio of the numbers of turns of the windings 50, 51 in a manner known per se, wherein one or both of the windings 50, 51, as illustrated by way of example in FIG. 4, can be switched by switchover between different taps 530.

FIG. 4 illustrates by way of example a switching device 53 at the secondary winding 50, which can be used to switch over between different taps 530 of the secondary winding 50. By switching over between the taps 530, it is possible to set the effective winding length of the winding 50 and thus the effective number of turns of the winding 50 in order in this way to vary the transformation ratio of the transformer 5.

The switching device 53 has switches 531, 532, which can be used to switch over between the different taps 530. In the case of the example in accordance with FIG. 4, the switch 531 assigned to a step S4 (corresponding to a specific transformation ratio) is closed, such that in the case of the illustrated switching position of the switch 532, the winding 50 is tapped at the tap 530 assigned to the step S4. By means of the different taps 530, it is possible to switch between different steps S1 to S7 corresponding to different, discrete values of the transformation ratio in order in this way to set the transformation ratio in a stepped manner.

The switching device 53 can be configured as an on load tap changer or else as a no load tap changer for switching between the taps 530.

A switchover can additionally or alternatively also be effected at the primary winding 51.

The switchover between the taps 530 for setting a desired transformation ratio is effected depending on a DC voltage U_{DC} available at the energy store 2, said DC voltage being dependent on the state of charge of the energy store 2. In this case, the switchover is controlled by way of the control device 7.

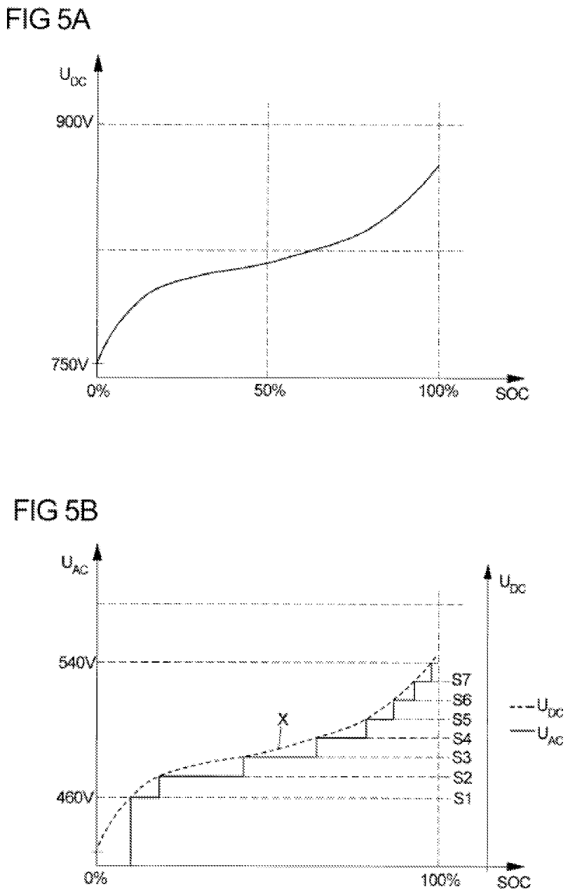

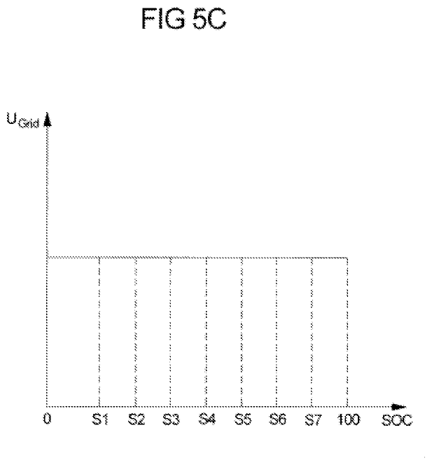

As is illustrated in FIG. 5A, the DC voltage U_{DC} available at the energy store 2 in the form of the battery changes depending on the state of charge (SOC). In this regard, the DC voltage U_{DC} is significantly lower when the battery is discharged or almost discharged (SOC close to 0%) compared with when the battery is fully charged (SOC at 100%). By way of example, the available DC voltage U_{DC} can vary between 750 V and 900 V, but in a manner dependent on the specific design of the energy store 2.

In order to be able to utilize the capacity of the energy store 2 with high efficiency, provision can be made for setting the AC voltage U_{AC} between power convertor 3 and transformer 5 in a variable manner, depending on the DC voltage U_{DC} at the energy store 2, as is illustrated in FIG. 5B. In this case, the AC voltage U_{AC} is set on the basis of a step function, wherein the AC voltage U_{AC} is varied on the basis of predetermined, discrete steps assigned to the steps S1 to S7 of the transformation ratio of the transformer 5.

In this case, the setting of the transformation ratio at the transformer 5 and the setting of the root-mean-square value of the AC voltage U_{AC} at the power convertor 3 are effected in a manner coordinated with one another and controlled by way of the control device 7, depending on the DC voltage U_{DC} available at the energy store 2.

In this case, different steps of the AC voltage U_{AC} are assigned to different value ranges of the DC voltage U_{DC} at the energy store 2. In this regard, on the basis of the equation

$${U}_{AC , max} = {k}_{M , max} \cdot \frac{{U}_{D C}}{K \sqrt{2}}$$

the root-mean-square value of the AC voltage U_{AC} that can be maximally obtained from an available DC voltage U_{DC} is calculated (K represents a safety factor); k_{M,max} denotes the maximum modulation factor with a permissible maximal value of less than or equal to 1. Depending on this, the root-mean-square value of the AC voltage U_{AC} is set by means of pulse width modulation in the power convertor 3 to the next lower step that is able to be set at the transformer 5:

$${U}_{AC , STEPm} = {U}_{AC} = {k}_{M} \frac{{U}_{D C}}{K \sqrt{2}} ,$$

where k_{M} represents a modulation factor (with a value of less than or equal to 1) of the pulse width modulation.

Depending on an available DC voltage U_{DC} at the energy store 2, the pulse width modulation at the power convertor 3 is thus controlled so as to result in a root-mean-square value of the AC voltage U_{AC} that corresponds to the respectively assigned step. Depending on the set step of the AC voltage U_{AC}, the transformation ratio of the transformer 5 is then set so that the (AC) line voltage U_{Grid} that is constant in terms of its root-mean-square value results after the transformation of the AC voltage U_{AC}, as is illustrated in FIG. 5C.

In particular, an AC voltage U_{AC} that is set on the basis of the step function illustrated as a solid line in FIG. 5B results on the output side of the power convertor 3. For a DC voltage value U_{DC}=X, for example, by means of pulse width modulation on the output side of the power convertor 3 the AC voltage U_{AC} is set in the manner corresponding to the step S3. By virtue of the fact that the transformation ratio at the transformer 5 is then set in such a way that precisely the line voltage U_{Grid} is established on the output side of the transformer 5, a constant line voltage U_{Grid} that is independent of the state of charge of the energy storage units 2 results on the part of the electrical network, as is illustrated in FIG. 5C.

This is effected in principle in this way both in the direction of feeding energy from the energy store 2 into the energy supply network 6 and conversely when feeding energy from the energy supply network 6 into the energy store 2.

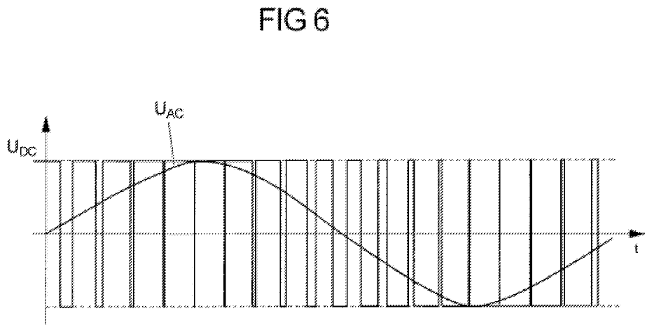

One example of a pulse width modulation for converting the DC voltage U_{DC} of the energy store 2 at the power convertor 3 to the energy supply network 6 is shown in FIG. 6. The DC voltage U_{DC} of the energy store 2 is “chopped” into pulses in the context of the pulse width modulation, which pulses, in terms of their mean value, produce a sinusoidal profile of the AC voltage U_{AC}. On the basis of the modulation factor of the pulse width modulation, in this case the root-mean-square value of the AC voltage U_{AC} can be set in a desired manner.

In the context of the proposed procedure, the AC voltage U_{AC} is thus set in a variable manner, depending on a DC voltage U_{DC} available at the energy store 2. Depending on the AC voltage obtained, the transformation ratio of the transformer is set in a stepwise manner, such that transformation between the line voltage U_{Grid} (which is constant in terms of its root-mean-square value) and the AC voltage U_{AC} is effected in a desired manner.

This makes it possible to utilize the capacity of an energy store 2 in the form of a battery to a great extent, in particular even in the case of very low states of charge. Moreover, by means of the proposed procedure, it is possible to obtain a high efficiency during the operation of the energy storage system 1. By virtue of the fact that the performance of the power convertor is principally determined by the current-carrying capacity of the IGBTs used, the energy capacity of an energy store 2 can be utilized in a wider scope.

The concept underlying the proposed solution is not restricted to the exemplary embodiments outlined above, but rather can in principle also be realized in an entirely different form.

Although described above on the basis of an energy storage system in the form of a battery power plant, the proposed procedure is also usable for other kinds of energy stores, for example energy stores in the form of capacitors or electromechanical flywheels. In this respect, it is possible to use very different energy stores which make an electrical DC voltage available.

A switchable transformer of the type described here can have a large number of steps, for example 20 steps or more for a finely stepped switchover of the transformation ratio.

### LIST OF REFERENCE SIGNS

1 Energy storage system (energy storage power plant)

2 Energy store

3 Power convertor

4 Generator transformer

5 Transformer

50 Primary winding

51 Secondary winding

52 Transformer core

53 Switching device

530 Tap

531 Switch

532 Switch

6 Energy supply network

7 Control device

S1-S7 Step

t Time

SOC State of charge

U_{DC} DC voltage

U_{AC} AC voltage

U_{grid} Line voltage

X DC voltage value

1. An energy storage system, comprising
at least one energy store;
a power convertor for converting between a DC voltage present at the at least one energy store and an AC voltage;
a transformer for transforming between the AC voltage and a line voltage of an energy supply network; and
a control device for controlling the energy storage system, wherein the transformer is switchable for setting a transformation ratio for converting between the AC voltage and the line voltage, wherein the control device is configured to set the transformation ratio of the transformer depending on the DC voltage present at the at least one energy store.

2. The energy storage system as claimed in claim 1, wherein the transformer is switchable in a stepwise manner for setting the transformation ratio.

3. The energy storage system as claimed in claim 1, wherein the transformer has a secondary winding, at which the AC voltage is present, a primary winding, at which the line voltage is present, and a switching device with a plurality of secondary taps at the secondary winding and/or with a plurality of primary taps at the primary winding.

4. The energy storage system as claimed in claim 3, the switching device is switchable for tapping the secondary winding via one of the secondary taps and/or the primary winding via one of the primary taps for setting the transformation ratio.

5. The energy storage system as claimed in claim 1, wherein the control device is configured to control the power convertor for converting between the DC voltage and the AC voltage, wherein the root-mean-square value of the AC voltage is dependent on the value of the DC voltage.

6. The energy storage system as claimed in claim 5, wherein the control device is configured to control the power convertor for setting the root-mean-square value of the AC voltage depending on the value of the DC voltage on the basis of a step function.

7. The energy storage system as claimed in claim 6, wherein different value ranges of the DC voltage are assigned to steps of the AC voltage.

8. The energy storage system as claimed in claim 5, wherein the power convertor is configured to set the root-mean-square value of the AC voltage by means of pulse width modulation.

9. The energy storage system as claimed in claim 8, wherein the control device predefines a modulation factor of the pulse width modulation on the basis of the value of the DC voltage.

10. The energy storage system as claimed in claim 5, wherein the control device is configured to set the transformation ratio of the transformer on the basis of a set step of the AC voltage.

11. The energy storage system as claimed in claim 1, wherein the energy storage system is configured as a battery storage power plant comprising at least one energy store in the form of a battery device.

12. The energy storage system as claimed in claim 1, wherein the control device is configured to control the power convertor for setting the maximum performance depending on the value of the AC voltage.

13. A method for controlling an energy storage system, wherein
a power convertor converts between a DC voltage present at least one energy store and an AC voltage, and
a transformer transforms between the AC voltage and a line voltage of an energy supply network,
wherein the transformer is switched for setting a transformation ratio for converting between the AC voltage and the line voltage depending on the DC voltage present at the at least one energy store.
